(19) United States
(12) Patent Application Publication
(10) Pub. No.: US 2020/0107504 A1
(43) Pub. Date: Apr. 9, 2020

(54) METHOD, LIGHTING SYSTEM AND GREENHOUSE

(71) Applicant: OSRAM GmbH, Munich (DE)

(72) Inventor: Timo Bongartz, Munich (DE)

(21) Appl. No.: 16/500,111

(22) PCT Filed: Mar. 29, 2018
(86) PCT No.: PCT/EP2018/058204

§ 371 Date: Oct. 2, 2019

(30) Foreign Application Priority Data
Apr. 6, 2017 (DE) 10 2017 205 845.5

(51) Int. Cl. A01G 7/04; F21V 21/34; A01G 9/24

(52) U.S. Cl. CPC A01G 7/045; A01G 9/249; F21V 21/34

(57) ABSTRACT

A method for illuminating plants and/or planting beds with a mobile light system may include moving the light system toward the plant as a function of a movement time plan. The method may further include irradiating the plant by means of the mobile light system. The mobile light system may include at least one radiation source for irradiating at least one plant and a holding device having at least one drive for changing position. The drive and the radiation source(s) may be controllable by means of a control unit.

### CROSS-REFERENCE TO RELATED APPLICATIONS

The present application is a national stage entry according to 35 U.S.C. § 371 of PCT application No.: PCT/EP2018/058204 filed on Mar. 29, 2018; which claims priority to German Patent Application Serial No.: 10 2017 205 845.5, which was filed on Apr. 6, 2017; all of which are incorporated herein by reference in their entirety and for all purposes.

### TECHNICAL FIELD

The present invention relates to illuminating plants and/or planting beds with a mobile light system.

### BACKGROUND

From the prior art, it is known that in horticulture different plant varieties have different illumination needs. These may differ in terms of a wavelength, a radiation intensity and an illumination duration during a day or a harvest cycle. Usually, a constant light spectrum is used for growing plants in a greenhouse. In order that the plants are grown under ideal conditions, it is necessary for them to be irradiated with variable light. Besides irradiation with the required light, in order to allow ideal and healthy growth of the plants, in the case of adaptable irradiation of the plants, their taste, nutrient content and shelf life may be influenced because of irradiation with different spectra.

From the prior art, irradiation algorithms are known in which short light methods are provided having radiation which has a specific wavelength at a specific instant with low photosynthetically active photon flux density (PPFD). These short-term light methods comprise for example dark-red radiation for simulating the end of a day, short-term ultraviolet (UV) radiation, night intermission radiation. The specific radiation is therefore used only temporarily.

A greenhouse which has variable radiation for irradiating the plants or planting beds provided therein is, however, extremely cost-intensive and elaborate in terms of equipment. Retrofitting of the illumination of existing greenhouses generally entails complete reinstallation of the illumination infrastructure.

### SUMMARY

A method for irradiating plants, such as in a greenhouse, may be performed optimally, economically, flexibly, and simply in terms of equipment. An economical light system and greenhouse may be provided that is configured simply in terms of equipment, with which plants can be irradiated flexibly.

The method may include, but is not limited to,

moving the mobile light system toward a plant or toward a planting bed as a function of a movement time plan, and
irradiating the plant or the planting bed by means of the mobile light system.

As an alternative or in addition, the method may include:

recording a plant status of the plant or of the planting bed,
determining a need for irradiation of the plant or of the planting bed on the basis of the recorded plant status, and
moving the mobile light system toward the plant or the planting bed based on the need for irradiation of the plant or of the planting bed.

This solution has the advantage that irradiation or additional irradiation of plants with a mobile light system may be carried out simply and economically with the method. Since the movement of the light system is carried out as a function of an, e.g. predetermined, movement time plan, regular approaching of a plant or a plurality of plants is for example made possible. Thus, a plant or individual plants or a planting bed or a plurality of planting beds may, for example, be approached and irradiated by the mobile light system in the morning and/or in the evening. Regular approach during a particular growth phase or growth cycle, during which a particular radiation treatment is advantageous, may also be straightforwardly carried out. Additional illumination is therefore implemented with the mobile light system, so that for example in the case of a stationary illumination system, for example in a greenhouse, additional functions for the stationary illumination system may be economized or not need to be installed.

After the irradiation of a plant, the mobile light system may then be moved to another plant, and may illuminate the latter, e.g. with an illumination pattern.

The demand-based irradiation of the plant has the advantage that a plant may be irradiated in a goal-orientated fashion, e.g. with additional radiation.

If a combination of the step sequences is provided—such that the method is adapted for both step sequences—, extremely individual and demand-based irradiation of plants is made possible in a way which is straightforward in terms of equipment.

The mobile light system may be designed according to one or more aspect(s) mentioned below.

Before the irradiation and/or during the irradiation and/or after the irradiation of the plant, the plant status may for example be determined, for example by means of the mobile light system. It is also conceivable for the mobile light system to determine the plant status of one or more plants during the movement according to the movement time plan. It is also conceivable that, when required, the movement time plan is paused or adapted—e.g. autonomously—in order to irradiate a plant on the basis of the plant status determined.

The plant status is, for example, the current growth phase of the plant and/or the size and/or the color of the plant and/or the budding of the plant and/or a nutrient content of the plant and/or a quality state of the plant and/or a pest infestation of the plant.

Advantageously, the plant is irradiated with an illumination pattern by means of the mobile light system. The plant may therefore, for example, be irradiated with radiation that varies over time, which may for example positively influence its growth. In a non-limiting embodiment, the mobile light system is controlled by a control unit in order to provide the illumination pattern.

In other words, a method for illuminating plants is provided, in which the mobile light system approaches/flies to a plant or a planting bed, e.g. on the basis of a movement time plan, and provides an illumination pattern as a function of the growth phase or else suitable for combating pests.

In another configuration of the method, the movement time plan and/or the illumination pattern is/are based on the plant status and/or a diurnal cycle and/or a photoperiod and/or a growth cycle of at least one plant to be tended and/or at least one planting bed to be tended and/or at least one plant type to be tended and/or at least one variety to be tended. As an alternative or in addition, the movement time plan and/or the illumination pattern may be a function of a pest infestation of at least one plant type to be tended and/or at least one variety to be tended. In other words, the illumination pattern and/or the movement time plan is/are configured as a function of the recorded plant status and/or plant requirement. This has the advantage that the plant may then be irradiated individually in terms of its plant status with an individual illumination pattern and with an individual movement time plan.

In non-limiting embodiments, determination of the plant status is carried out by means of a chemical-biological measurement and/or an optical measurement and/or a spectral measurement. If one of these measurements or a plurality of these measurements are used, individual recording of the plant status may straightforwardly be carried out, in order then to provide a corresponding illumination pattern and/or a corresponding movement time plan.

The plant status may be recorded by a sensor of the mobile light system and/or by at least one sensor which is external to the mobile light system.

Advantageously, the illumination pattern and/or the movement time plan may be called up from a database. The required information may therefore be provided extremely rapidly and straightforwardly. The calling-up of the illumination pattern and/or the movement time plan from the database is, for example, carried out as a function of the measurement of the plant status. A particular illumination pattern and/or a particular movement time plan may therefore be assigned to a particular plant status. A respective illumination pattern and/or a respective movement time plan is for example preadjusted and/or determined computationally, e.g. beforehand. As an alternative or in addition to the database access, the illumination pattern and/or the movement time plan may be determined and/or calculated and/or adapted in real time on the basis of the plant status, e.g. by means of the control unit, in order to provide an illumination pattern and/or movement time plan oriented extremely accurately at the plant status. The database may, for example, be stored on a data medium of the mobile light system and/or on a memory or server, to which the control unit may be connected. The database may therefore, for example, also be formed externally, in which case the control unit accesses it for example wirelessly. In other words, a previously adjusted or computationally determined illumination spectrum or an illumination function may be called up from a database.

Further, the mobile light system is straightforwardly controlled autonomously. As an alternative or in addition, the at least one radiation source of the mobile light system may be controlled autonomously.

It is also conceivable to irradiate only particular components of the plant or parts of the plant, which for example require strengthening.

In non-limiting embodiments, the illumination pattern has a multiplicity of illumination punctual.

In another non-limiting embodiment, the illumination pattern may provide an output of radiation with different wavelengths. For example, it is conceivable to irradiate a plant for instance with reddish light and/or ultraviolet (UV) light. As an alternative or in addition, the illumination pattern may provide an output of radiation with different spectra, the wavelengths of which range from infrared to ultraviolet. Infrared radiation may, for example, assist the growth process and/or the thermal budget of the plants. As an alternative or in addition, the illumination pattern may provide an output of radiation with different radiation intensities. In order to further adapt the illumination pattern to the requirements of the plant, as an alternative or in addition the illumination pattern may provide an output of radiation with an adjustable radiation period. As an alternative or in addition, the illumination pattern may provide an output of radiation with an adjustable radiation start and an adjustable radiation end. It is conceivable for the illumination pattern to provide an output of radiation with an adjustable light field or radiation field, wherein a size and/or a position of the light field is adjustable, for example. Furthermore, it is conceivable, alternatively or in addition, for the illumination pattern to provide an output of radiation having an adjustable distance from the plant and/or an adjustable direction. If the illumination pattern comprises one or more of these functionalities, influence may be exerted extremely individually on the plant status of a respective plant by means of the radiation source.

A mobile light system for horticulture, e.g. for a greenhouse or hothouse or glasshouse or indoor greenhouse, may illuminate at least one plant or at least one planting bed. The mobile light system may be provided for the method according to one or more of the aspects above. The light system may have a holding device which comprises at least one radiation source for irradiating the at least one plant. In non-limiting embodiments, the holding device has a drive for moving it or for changing a position of it. The drive and the radiation source are advantageously controllable by means of a control unit.

This solution has the advantage that the mobile light system, for example in a greenhouse, can be moved flexibly to different positions by means of the drive and can therefore irradiate different plants. By means of the control unit, the radiation source may for example be switched on and off. For example, the light system may then be used as a kind of additional light source with respect to existing illumination of the greenhouse, in order for example to additionally irradiate individual plants when required. For additional irradiation of plants, no retrofitting of the illumination of the entire greenhouse is therefore necessary, but rather the mobile light system may, for example, straightforwardly be used economically and simply in terms of equipment in a conventional greenhouse. It is also conceivable to carry out tests or trial operation with the mobile light system in existing greenhouses, in order to find out whether retrofitting of the greenhouse with an additional illumination function is expedient.

For the sake of completeness, it is pointed out that the mobile light system may be configured according to one or more of the aspects mentioned in the method.

In another configuration of the method or of the mobile light system, the control unit may control the radiation source in such a way that an illumination pattern for the at least one plant is provided by the radiation source.

In another configuration of the method or of the mobile light system, as already mentioned above, at least one sensor may be provided for recording a plant status and/or a plant requirement of a plant. In this case, for example, it is conceivable that the plant is then irradiated as a function of the plant status. The radiation source and/or the mobile light system may therefore be controlled as a function of the plant status.

Advantageously, a position change of the holding device and/or of the radiation source in a horizontal plane and/or in a vertical direction is made possible with the drive. It is, for example, conceivable to move the holding device and/or the radiation source in an arbitrary spatial direction or at least in one plane. It is furthermore conceivable to rotate the holding device about at least one axis or about two or about three axes with the drive, wherein, if a plurality of axes are provided, these may respectively be perpendicular to one another. An extremely flexible position change of the holding device and/or of the radiation source may therefore be made possible, in order to guide the light system to a desired position in a very wide variety of ambient conditions.

In another non-limiting embodiment, the holding device is configured for example as a ground vehicle. For movement, the holding device may then comprise at least one wheel and/or at least one continuous track and/or at least one air cushion, or be moved in another way on a surface.

As an alternative or in addition, the holding device may be configured as an aircraft. If the holding device is configured as a combination of ground vehicle and aircraft, it may when required be moved on the ground or raised from the ground. If the holding device is configured as an aircraft, configuration in the form of a drone or a rigid airship, for example a dirigible, or a helicopter or an airplane, may be suitable for this. If the holding device is provided as a drone, the drive may comprise a multiplicity of, for example at least three or four, rotors. Configuration as a drone or rigid airship has the advantage that the holding device can straightforwardly be kept in a particular position. In other words, the holding device is configured as an aircraft in such a way that the holding device can be kept at a particular position in the air.

In one non-limiting embodiment, it is conceivable to hold the holding device by means of a tensioned cable or by means of a plurality of tensioned cables, e.g. hanging. The holding device is then self-propelled along the at least one cable and/or can be moved by at least one cable. If the holding device is self-propelled, it may be movable relative to the cable or the cables. By this drive, the holding device may be flexibly arranged compactly hanging in the air. When it is at a particular position, in contrast for example to a drone, no energy is consumed in order to hold the position. In other words, the holding device may be suspended in a spider-like fashion, or arranged hanging.

In one non-limiting embodiment, the holding device and/or the at least one radiation source is controlled autonomously. The holding device and/or the radiation source may therefore be controlled without the intervention of a human operator, for example in order to approach different positions and/or to irradiate different plants with different illumination patterns.

In another non-limiting embodiment, the holding device may be configured as a driverless transport vehicle which can be controlled automatically and guided contactlessly.

In another non-limiting embodiment, the at least one radiation source has at least one light-emitting diode (LED).

The at least one radiation source may be connected to the holding device by means of an adjustment device. By means of the latter, a radiation device and/or a position of the LED may then be variable relative to the holding device. For example, it is therefore conceivable for the radiation source to be guided by means of the adjustment device to positions which would not be reachable by the holding device. In non-limiting embodiments, the adjustment device can be set by means of the control unit.

In another non-limiting embodiment, for example UV radiation may be emittable by the at least one radiation source. This is extremely advantageous in order to irradiate plants against mold or mildew. For example, the holding device in the form of a drone may then fly from plant to plant in order to respectively irradiate said plants with the UV radiation. It is also conceivable that the at least one radiation source may emit dark-red, e.g. far-red, radiation, in order for example to simulate the end of a day. It is also conceivable for the at least one radiation source to emit radiation in the visible spectrum.

In non-limiting embodiments, the light system has a communication instrument, which is for example provided on the holding device. The holding device may therefore connect for example the at least one radiation source and/or the control unit and/or the drive to at least one other means. The communication instrument is configured in such a way that a wireless and/or cable connection to further means is possible. If the communication instrument is configured wirelessly, it may be set up in terms of the Wi-Fi standard. It is also conceivable to provide the communication instrument as part of a radio network, for example a wireless local area network (WLAN). As a wireless connection, as an alternative or in addition, optical data transmission may be provided, for example Li-Fi. It is also conceivable to set up a radio connection and/or Bluetooth connection as a wireless connection. In non-limiting embodiments, the holding device, e.g. the drive of the holding device, and the at least one radiation source are controlled wirelessly by means of a control unit by the communication instrument.

In a non-limiting embodiment, the control unit may be provided in the holding device and/or the control unit and a further control unit is/are connected by means of the communication instrument to the holding device, e.g. to the radiation source and/or the drive.

In another non-limiting embodiment, the holding device and/or the at least one radiation source is moved on the basis of a movement time plan and/or on the basis of the illumination pattern. In another non-limiting embodiment, it is conceivable for the movement time plan and/or the illumination pattern to be compiled and/or predetermined and/or adapted by the control unit, e.g. independently. Economically, therefore, no compilation or adaptation by means of an operator is necessary, rather it may for example be carried out automatically. In another non-limiting embodiment, the movement time plan and/or the illumination pattern may be compiled and/or predetermined and/or adapted by the control unit, e.g. independently, on the basis of the at least one plant type to be tended and/or on the basis of at least one variety to be tended of the at least one plant type. It is furthermore conceivable for the movement time plan and/or the illumination pattern to be compiled and/or predetermined and/or adapted by the control unit, e.g. independently, on the basis of the recorded plant state and/or plant requirement. For example, the plant status may therefore be recorded by means of the sensor and the control unit may compile and/or adapt the movement time plan and/or the illumination pattern on the basis of these data.

The movement time plan and/or the illumination pattern may be stored on the data medium of the holding device and/or on the data medium to which the control unit can be connected.

In non-limiting embodiments, different plant types and/or different varieties of at least one plant type may be recorded and/or identified by a sensor or by the at least one sensor or by at least one further sensor. It is therefore conceivable for the holding device to travel independently through the greenhouse and record which plant types and/or varieties are present therein, for example in order to form or adapt the movement time plan and/or the illumination pattern therefrom. Furthermore, the plant state of at least one plant may be determinable by a sensor or by the at least one sensor or by at least one further sensor. This is, for example, a quality state of the plant and/or a growth state of the plant.

In order to record the plant state, it is furthermore conceivable to provide a sensor or the at least one sensor or at least one further sensor by which a nitrogen deficit of a plant may be recorded. It is furthermore possible to arrange at least one sensor or the at least one sensor or at least one further sensor which can determine harvest image acquisition for growth features of a plant.

In order to make it possible to combat infestation, at least one infestation type or infestations may be recordable by a sensor or the at least one sensor or at least one further sensor.

In terms of equipment, the at least one sensor and/or the at least one further sensor or some of the sensors or all the sensors are straightforwardly arranged on the holding device, so that the environment can be recorded directly on the holding device. It is also conceivable for the at least one sensor and/or the at least one further sensor or some of the sensors or all the sensors to be connected wirelessly or by means of a cable to the holding device. It is therefore conceivable, for example, to position one or more sensor(s) at a plant or a plurality of plants and to transmit the data determined to the control unit, for example wirelessly. It is also possible for at least one sensor to be movable independently of the holding device and thus able for example to examine plants independently of the position of the holding device. The sensor may then, for example, be configured to move and/or fly and/or hang in a similar way as the holding device.

The sensor(s) is an optical sensor, a fluid sensor, or both. It is also conceivable to use a plurality of identical or different sensors of this group.

The optical sensor may be a hyperspectral sensor, a fluorescence sensor, an infrared sensor, or combinations thereof. It is conceivable to select a plurality of identical or different sensors of this group. Furthermore, it is conceivable for the at least one optical sensor to be configured as a camera.

The fluid sensor is an air sensor, a water sensor, or both. It is conceivable to provide a plurality of identical or different sensors of this group. The sensor may in turn be a temperature sensor, such as for recording an air temperature, e.g. the ambient air of the plant; a humidity sensor; a carbon dioxide (CO₂) sensor; or combinations thereof. It is conceivable to provide a plurality of identical or different sensors of this group. The water sensor may be a moisture sensor, an oxidation-reduction potential sensor, a pH sensor, an electrical conductance sensor, a dissolved-oxygen sensor, a water temperature sensor, a water volume flow sensor, an ammonia sensor, a nitrate sensor, a nitrite sensor, or combinations thereof. It is conceivable to provide a plurality of identical or different sensors of this group.

In order that the holding device is flexibly movable, it is conceivable for it to comprise at least one battery and/or at least one accumulator for the power supply. In this way, for example, an interfering cable connection to the power supply may be obviated. It is furthermore conceivable to provide at least one solar cell, which may be connectable to the holding device. In this way, for example, the power supply may be carried out by means of artificial light or sunlight in a greenhouse. It is furthermore conceivable for charging of the accumulator to be carried out by means of the solar cell. In another non-limiting embodiment, the photosynthesis of the plants is used for the power supply.

In order to improve the control, e.g. of the holding device, a position determination system may be provided in order to establish a position. The position determination device may, for example, simply in terms of equipment be a receiver of a global satellite navigation system, e.g. a GPS and/or GLONASS and/or Galileo and/or Beidou receiver. As an alternative or in addition, an indoor position determination system may be provided. Furthermore, as an alternative or in addition, it is possible to provide a position determination system in which a position determination is carried out with the aid of at least one image from a camera, e.g. a 3D camera, or the camera. The position determination system is part of the holding device.

In other words, the advantage of the mobile light system is that it has high flexibility in terms of an autonomous movement path, in terms of access at different heights, for example in vertical farms or planting beds, radiation angle flexibility, dosing flexibility, such as in terms of a distance from the plant, and also high flexibility in terms of power, speed and time.

According to non-limiting embodiments, a greenhouse having a mobile light system according to one or more of the aspects above is provided, and/or a method according to one or more of the aspects above is carried out in the greenhouse. With the greenhouse, it is possible for plants contained therein to be irradiatable with a short light method by means of the mobile light system, without the entire greenhouse having to be equipped with corresponding radiation sources, this being extremely cost-efficient.

Horticulture may comprise growth of crop plants comprising inter alia medicinal plants and herbs, fruit, vegetables, nuts, seeds, plantlets, mushrooms, algae, flowers, seaweed and also other plants such as grass, ornamental trees, etc. Besides horticulture, it is also conceivable to use the mobile light system for pisciculture, animal husbandry, insect farming, etc.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the illumination apparatus. In the following description, various aspects are described with reference to the following drawings, in which:

FIG. 1 shows a schematic representation of a greenhouse with a mobile light system, and

FIG. 2 shows a flowchart of a method according to one exemplary embodiment.

### DETAILED DESCRIPTION

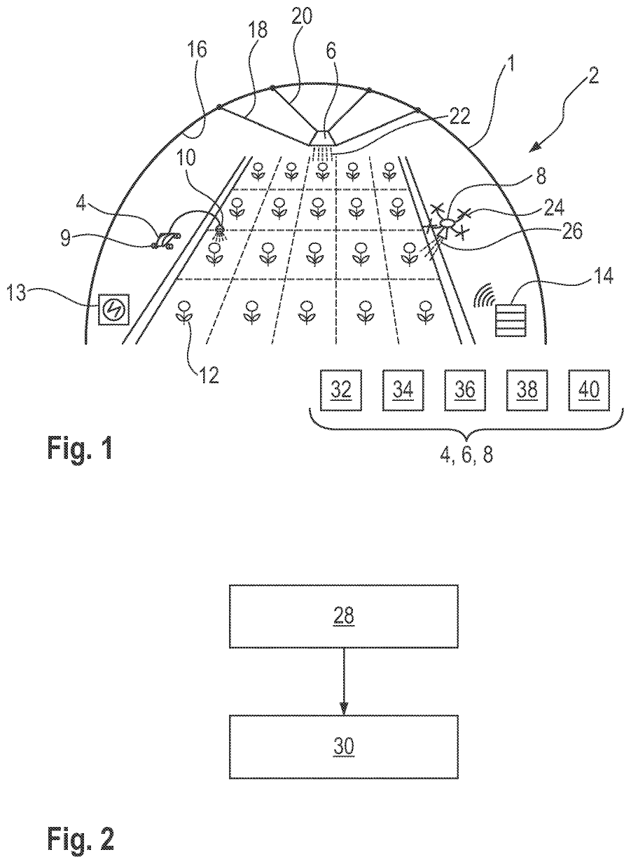

According to FIG. 1, a greenhouse 1 having a mobile light system 2 is shown, which is used for the method according to the invention. According to FIG. 1, holding devices 4, 6 and 8 having different drives are shown. The holding device 4 is configured as a ground vehicle having four wheels 9, at least one of which being drivable by a drive. For the sake of simplicity, only one wheel 9 is provided with a reference sign. This device can therefore be moved on the floor of the greenhouse 1. Furthermore, the holding device 4 has a radiation source 10 by means of which plants 12, only one of which is provided with a reference sign in FIG. 1 for the sake of simplicity, can be irradiated with an illumination pattern. The holding device 4 furthermore comprises a schematically represented battery 13 for the power supply and has a control unit, by means of which the drive and the radiation source can be controlled. By means of a communication instrument which is fastened on the holding device 4, a connection to a server 14 can be established wirelessly, for example in order to connect the latter to the control unit and/or the radiation source and/or the drive.

As an alternative or in addition to the holding device 4, the light system 2 may comprise the holding device 6. The latter is in this case suspended by means of two cables 18, 20 from an inner wall 16 of the greenhouse 1. By means of a drive of the holding device 6, which engages with the cables 18, 20, the holding device 6 can move relative to the cables 18, 20. By the hanging arrangement of the holding device 6, it can be suspended above the plants 12. In a corresponding way to the holding device 4, the holding device 6 likewise has a radiation source 22 and may furthermore have corresponding components like the holding device 4, e.g. a control unit, a battery and a communication instrument.

As alternative or in addition to the holding device 4 and/or the holding device 6, the light system 2 of FIG. 1 may comprise the holding device 8 which is configured in the form of an aircraft in the form of a drone. To this end, the holding device 8 comprises four rotors 24, only one of which is provided with a reference sign for the sake of simplicity. The holding device 8 can therefore fly flexibly in the greenhouse 1. The holding device 8 likewise comprises a radiation source 26 and may have corresponding components like the holding device 4, e.g. a control unit, a battery and a communication instrument. Furthermore, a sensor, or respectively a sensor, for recording a plant state of the plants 12 may be provided for one or more holding devices 4 to 8.

According to FIG. 1, the following components of the holding devices 4 to 8 are shown only schematically for the sake of simplicity: control unit 32, communication instrument 34, sensor 36, drive 38, and as explained above these may be part of the holding devices 4 to 8. A position determination system 40 may furthermore be provided.

According to FIG. 2, a method for controlling the light system 2 of FIG. 1 is represented. In the method, a mobile light system 2 which comprises at least one of the holding devices 4 to 8 may be provided. It is conceivable to provide a plurality of identical or different holding devices. In a first step 28, at least one of the holding devices 4 to 8 is moved toward a plant 12 by means of the respective drive. The plant 12 is subsequently irradiated with an illumination pattern in a step 30. The movement of at least one of the holding devices 4 to 8 is in this case based on a movement time plan.

Examples of short-term irradiations of plants and the effects thereof are given below.

If, for example, simulation of the end of a day is carried out using dark-red irradiation of tomato plants of 1.1 mmol/m² d (daily light integral, DLI) with a radiant flux of 6 μmol/m² s for three minutes, so-called intumescence damage may be significantly reduced.

It has furthermore been found that by irradiation at the end of a short day, for example in order to lengthen the day, or at night in order to interrupt the night, regulation of flower formation of so-called long-day plants and short-day plants may be carried out. A multiplicity of LEDs may in this case be provided as the radiation source. The light intensity may in this case lie between 1 and 4 μmol/m² s (low light intensity) or up to 30 μmol/m² s (moderate light intensity). In this case, individual or multiple spectra may be used. The wavelengths may in this case, for example, for the low light intensity lie between red (600 to 700 nm) and dark-red (700 to 800 nm), in order to promote blossoming of long-day plants. In non-limiting embodiments, wavelengths of between 600 and 700 nm may be used in order to inhibit blossoming of short-day plants.

With a short-term illumination at high levels of photosynthetically active photon flux density (PPFD) and red light, for example with a wavelength of 638 nm, which may for example be emitted by means of LEDs, secondary metabolites of microgreens may be increased, e.g. three days before harvesting. Furthermore, nutrient content compounds in microgreens may be influenced in this way. Microgreens are young plants after the sprouting stage.

Furthermore, different spectra of radiation of a radiation source, such as an LED, may lead to different effects in red and green foliage plants. For example, a phytochemical compound may be modified, e.g. in young leaves. In green perillas, for example, a significantly higher amount of α-carotenes, violaxanthin and neoxanthin may occur when red and green or ultraviolet (UV-A) radiation are combined.

Furthermore, UV irradiation makes an increase of ORAC values possible (ORAC: Oxygen Radical Absorption Capacity). With UV-B radiation, for example, the biosynthesis of anthocyanin and other antioxidant polyphenols may be stimulated. In non-limiting embodiments, additional UV radiation between one and three days before harvesting may be extremely effective for the production of lettuces having plentifully functional secondary plant contents.

A method is disclosed having a mobile light system with a holding device, which comprises a radiation source and can be moved in a space by means of a drive. The drive and the radiation source can be controlled, e.g. autonomously, by means of a control unit.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes that come within the meaning and range of equivalency of the claims are therefore intended to be embraced.

### LIST OF REFERENCE SIGNS

| | |
|---|---|
| greenhouse | 1 |
| light system | 2 |
| holding device | 4, 6, 8 |
| wheel | 9 |
| radiation source | 10, 22, 26 |
| plants | 12 |
| server | 14 |
| inner wall | 16 |
| cable | 18, 20 |
| rotor | 24 |
| steps | 28, 30 |
| control unit | 32 |
| communication instrument | 34 |
| sensor | 36 |
| drive | 38 |
| position determination system | 40 |

1. A method for illuminating plants and/or planting beds with a mobile light system; wherein the method comprises:
moving the light system toward the plant based on a movement time plan; and
irradiating the plant by means of the mobile light system.

2. The method of claim 1, further comprising:
recording a plant status of the plant or of the planting bed;
determining a need for irradiation of the plant or of the planting bed on the basis of the recorded plant status;
moving the mobile light system toward the plant or the planting bed based on the need for irradiation of the plant or of the planting bed; and
irradiating the plant or the planting bed with the mobile light system.

3. The method as claimed in claim 1, wherein a control unit controls the mobile light system to provide an illumination pattern for the at least one plant.

4. The method as claimed in claim 1, wherein the movement time plan and/or the illumination pattern is/are based on a plant status, and/or wherein the movement time plan and/or the illumination pattern is/are a function of a pest infestation.

5. The method as claimed in claim 4, wherein the plant status is determined based on a chemical-biological measurement, an optical measurement, a spectral measurement, the illumination pattern, the movement time plan, or combinations thereof being configured as a function of the recorded plant status.

6. The method as claimed in claim 4, wherein the plant status is recorded by a sensor of the mobile light system and/or wherein the plant status is recorded by a sensor independent of the mobile light system.

7. The method as claimed in claim 1, wherein the illumination pattern and/or the movement time plan is/are called up from a database.

8. The method as claimed in claim 1, wherein the mobile light system is autonomously controlled, and/or wherein at least one radiation source of the mobile light system is autonomously controlled.

9. The method as claimed in claim 3, wherein the illumination pattern provides an output of radiation with different wavelengths, an output of radiation with different spectra, an output of radiation with different radiation intensities, an output of radiation with an adjustable radiation period, an output of radiation with an adjustable radiation start and end, an output of radiation with an adjustable light field, an output of radiation with an adjustable distance, an adjustable direction, or combinations thereof.

10. A mobile light system comprising:
a holding device having:
at least one radiation source for irradiating at least one plant
at least one drive for changing position, wherein the at least one drive and the at least one radiation source are controllable by means of a control unit.

11. The mobile light system as claimed in claim 10, wherein the holding device is configured as a ground vehicle or an aircraft, or wherein the holding device is held by means of one or more cables and is self-propelled and/or can be moved by means of at least one cable.

12. The mobile light system as claimed in claim 10, wherein the holding device comprises a communication instrument, and/or wherein at least one battery and/or at least one accumulator is provided for the power supply in the holding device, and/or wherein a position determination system is provided in the holding device.

13. A greenhouse comprising the mobile light system as claimed in claim 10.
